(19) United States
(12) Patent Application Publication
(10) Pub. No.: US 2025/0380075 A1
(43) Pub. Date: Dec. 11, 2025

(54) Bone Conduction Package Structure

(71) Applicant: AAC ACOUSTIC TECHNOLOGIES (SHENZHEN) CO., LTD., Shenzhen (CN)

(72) Inventors: Kaijie Wang, Shenzhen (CN); Shitao Yan, Shenzhen (CN)

(21) Appl. No.: 18/984,917

(22) Filed: Dec. 17, 2024

Related U.S. Application Data
(63) Continuation of application No. PCT/CN2024/097644, filed on Jun. 6, 2024.

(51) Int. Cl. H04R 1/08; H04R 7/16; H04R 19/04

(52) U.S. Cl. CPC H04R 1/08; H04R 7/16; H04R 19/04; H04R 2201/003

(57) ABSTRACT

The present invention provides a bone conduction package structure including a base board, a housing covered with the base board to form a receiving room, a bone conduction MEMS chip and an ASIC chip located in the receiving room. The bone conduction MEMS chip includes a substrate, a diaphragm, and a backplate. A first cavity is formed between the diaphragm and the backplate. A second cavity is formed by the diaphragm, the substrate, and the base board. And a third cavity is formed by the backplate, the housing, the substrate, and the base board. The first cavity is set as a low-pressure area below atmospheric pressure. The bone conduction package structure of the present invention sets the area between the diaphragm and the backplate as a low-pressure area to reduce damping between the diaphragm and backplate, thereby improving the performance of the bone conduction package structure.

### FIELD OF THE PRESENT INVENTION

The present invention relates to the field of acoustic-electro conversion, and more particularly, to a bone conduction package structure.

### DESCRIPTION OF RELATED ART

The bone conduction microphone converts the slight vibrations of the bones of the head and neck caused by human speech into electric signals. Since it is different from the traditional microphone that collects sound through air conduction, it can restore the sound with high definition even in a noisy environment, so as to avoid the noise interference caused by air-borne sound, and ensure the sound weight extremely high.

In related art, the bone conduction package structure includes a housing, a circuit board enclosed with the housing to form a containment space, a vibration assembly and a MEMS chip arranged in the containment space. The vibration assembly includes a vibration plate arranged opposite and spaced apart from the circuit board, a frame connecting the vibration plate and the circuit board, and a weight arranged on the vibration plate. When the bone conduction package structure is in operation, the housing receives vibration signals or pressure signals, and the vibration plate and weight are excited by the vibration signals or pressure signals. The weight and vibration plate vibrate, causing a gas in the containment space to vibrate and change the air pressure inside the containment space. The MEMS chip detects this change of the air pressure and converts the sensed information into detectable electrical signals, which are transmitted to the circuit board. However, the bone conduction package structure of related art has a large volume and poor performance.

Therefore, it is desired to provide a new bone conduction package structure which can overcome the above problems.

### SUMMARY

In view of the above, the embodiments of the present invention provide a new bone conduction package structure having a better performance.

The present invention provides a bone conduction package structure including a base board, a housing covered with the base board to form a receiving room, a bone conduction MEMS chip located in the receiving room, and an ASIC chip located in the receiving room. The bone conduction MEMS chip includes a substrate having a chamber, a diaphragm supported on the substrate, and a backplate spaced apart from the diaphragm and arranged on one side of the diaphragm distal to the substrate. A first cavity is formed between the diaphragm and the backplate. A second cavity is formed by the diaphragm, the substrate, and the base board. And a third cavity is formed by the backplate, the housing, the substrate, and the base board. The first cavity is set as a low-pressure area below atmospheric pressure.

As an improvement, the diaphragm is a complete and impermeable structure, and the backplate is a complete and impermeable structure.

As an improvement, the diaphragm includes a plurality of first ventilation holes, the first ventilation holes communicating the first cavity and the second cavity, the second cavity is set as the low-pressure area below atmospheric pressure.

As an improvement, the backplate includes a plurality of second ventilation holes, the second ventilation holes communicating the first cavity and the third cavity, the third cavity is set as the low-pressure area below atmospheric pressure.

As an improvement, the diaphragm includes a plurality of first ventilation holes, the first ventilation holes communicating the first cavity and the second cavity, the second cavity is set as the low-pressure area below atmospheric pressure, the backplate including a plurality of second ventilation holes, the second ventilation holes communicating the first cavity and the third cavity, the third cavity is set as the low-pressure area below atmospheric pressure.

As an improvement, a weight is provided on a side of the diaphragm away from the backplate.

As an improvement, the bone conduction MEMS chip further includes at least one connecting column connecting the weight to the diaphragm on the side of the diaphragm away from the backplate.

As an improvement, a plurality of anti-stick pillars are disposed on a side of the backplate proximal to the diaphragm.

### BRIEF DESCRIPTION OF THE DRAWINGS

Many aspects of the exemplary embodiments can be better understood with reference to the following drawing. The components in the drawing are not necessarily drawn to scale, the emphasis instead being placed upon clearly illustrating the principles of the present invention. Moreover, in the drawings, like reference numerals designate corresponding parts throughout the several views.

FIG. 1 is an illustrative isometric view of a MEMS chip of a bone conduction package structure in accordance with one embodiment of the present invention.

FIG. 2 is an exploded view of the MEMS chip of FIG. 1.

FIG. 3 is an illustrative cross-sectional view of the bone conduction package structure of the first embodiment of the present invention.

FIG. 4 is an illustrative cross-sectional view of the bone conduction package structure of the second embodiment of the present invention.

FIG. 5 is an illustrative cross-sectional view of the bone conduction package structure of the third embodiment of the present invention.

FIG. 6 is an illustrative cross-sectional view of the bone conduction package structure of the fourth embodiment of the present invention.

### DETAILED DESCRIPTION OF THE EXEMPLARY EMBODIMENTS

The present invention will hereinafter be described in detail with reference to exemplary embodiments. To make the technical problems to be solved, technical solutions and beneficial effects of the present invention more apparent, the present invention is described in further detail together with the figures and the embodiments. It should be understood the specific embodiments described hereby is only to explain the disclosure, not intended to limit the disclosure.

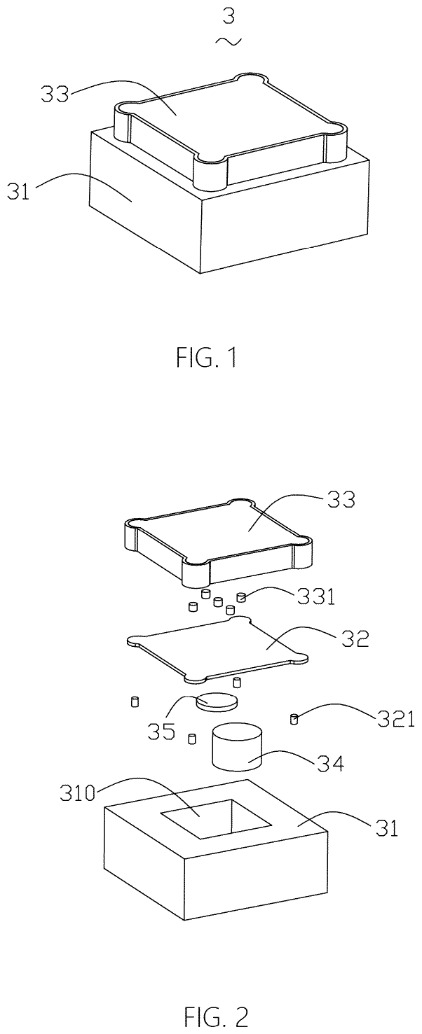

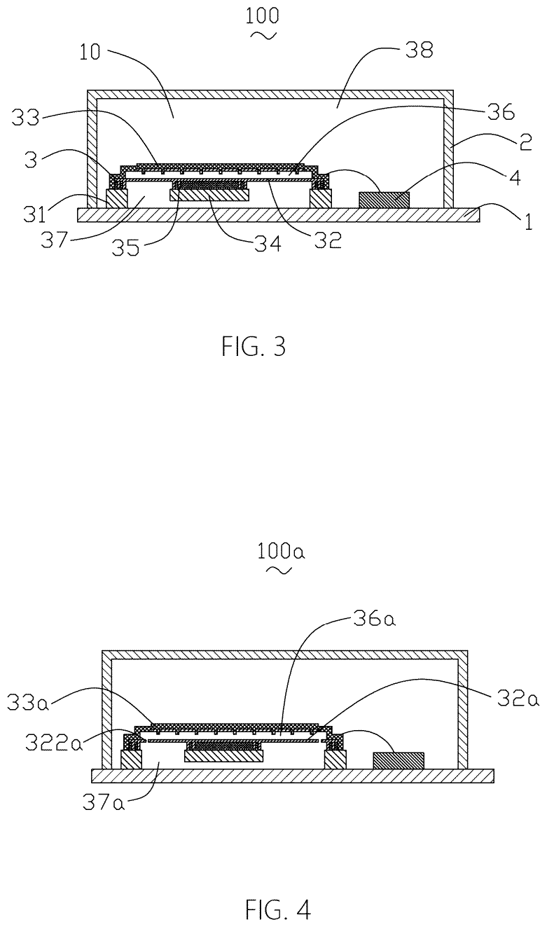

Referring to the FIGS. 1-3, the present invention provides a bone conduction package structure 100 of the first embodiment. The bone conduction package structure 100 includes a base board 1, a housing 2 covered with the base board 1 to form a receiving room 10, a bone conduction MEMS chip 3 located in the receiving room 10, and an ASIC chip 4 located in the receiving room 10.

The base board 1 is a circuit board. The housing 2 can be a metal housing.

The bone conduction MEMS chip 3 includes a substrate 31 having a chamber 310, a diaphragm 32 supported on the substrate 31, a backplate 33 spaced apart from the diaphragm 32 and arranged on one side of the diaphragm 32 distal to the substrate 31, and a weight 34 provided on a side of the diaphragm 32 away from the backplate 33. The weight 34 and the substrate 31 are made of the same material. The bone conduction MEMS chip 3 further includes at least one connecting column 35 connecting the weight 34 to a side of the diaphragm 32 away from the backplate 33. In this embodiment, there are a plurality of connecting columns 35 connecting the weight 34 to the diaphragm 32. In other embodiments, the connecting column 35 may be a single piece structure. The weight 34 locates in the chamber 310. The bone conduction MEMS chip 3 further includes a plurality of support columns 321 connecting the diaphragm 32 to the substrate 31, and the diaphragm 32 is integrally formed with the support columns 321. A plurality of anti-stick pillars 331 are disposed on a side of the backplate 33 proximal to the diaphragm 32. The anti-stick pillars 331 can prevent the diaphragm 32 from adhering to the backplate 33 when the diaphragm 32 vibrates.

The present invention directly arranges a weight 34 on the diaphragm 32 of the bone conduction MEMS chip 3, so that the sensitivity of the bone conduction MEMS chip 3 can be flexibly adjusted by directly adjusting the size of the weight 34, which is highly practical. At the same time, the bone conduction package structure 100 provided by the present invention avoids the additional vibration plates and weights in the receiving space 10, so the present invention reduces the costs, simplifies packaging, and allows for a smaller structure.

A first cavity 36 is formed between the diaphragm 32 and the backplate 33. A second cavity 37 is formed by the diaphragm 32, the substrate 31, and the base board 1. And a third cavity 38 is formed by the backplate 33, the housing 2, the substrate 31, and the base board 1. In this embodiment, the diaphragm 32 is a complete and impermeable structure, and the backplate 33 is also a complete and impermeable structure. So the diaphragm 32 and the backplate 33 can seal the first cavity 36. And furthermore, the first cavity 36 is set as a low-pressure area below atmospheric pressure, which can reduce the damping between the diaphragm 32 and the backplate 33 and improve the performance of the bone conduction encapsulation structure 100.

Referring to FIG. 4, the present invention provides a bone conduction package structure 100a of the second embodiment. The difference between the second embodiment and the first embodiment is that, in the second embodiment, the diaphragm 32a includes a plurality of first ventilation hole 322a. The first ventilation holes 322a communicate the first cavity 36a and the second cavity 37a. And the second cavity 37a is further set as the low-pressure area below atmospheric pressure. The above structure can reduce the damping between the diaphragm 32a and the backplate 33a, and improve the performance of the bone conduction encapsulation structure 100a.

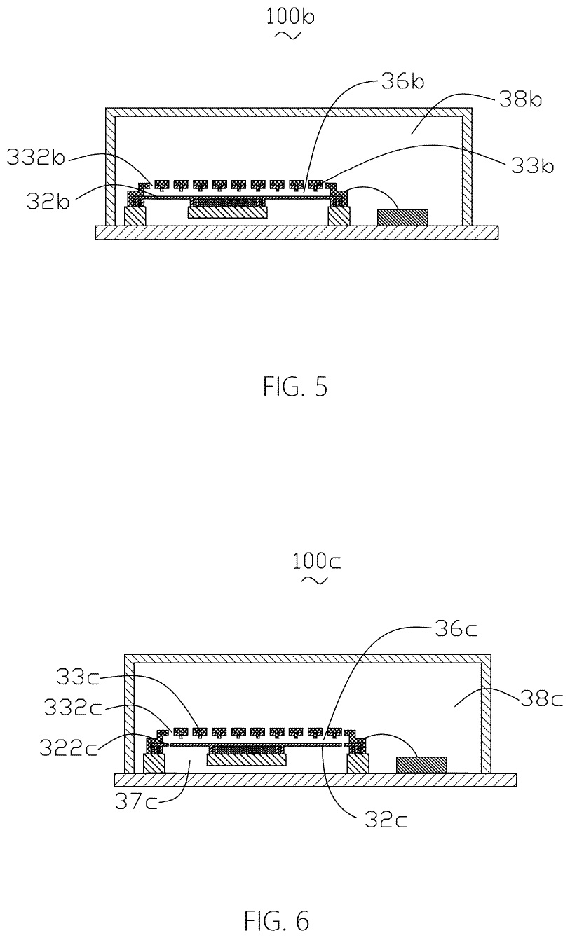

Referring to FIG. 5, the present invention provides a bone conduction package structure 100b of the third embodiment. The difference between the third embodiment and the first embodiment is that, in the third embodiment, the backplate 33b includes a plurality of second ventilation hole 332b. The second ventilation holes 332a communicate the first cavity 36a and the third cavity 38a. And the third cavity 38a is further set as the low-pressure area below atmospheric pressure. The above structure can reduce the damping between the diaphragm 32b and the backplate 33b, and improve the performance of the bone conduction encapsulation structure 100b.

Referring to FIG. 6, the present invention provides a bone conduction package structure 100c of the fourth embodiment. The difference between the fourth embodiment and the first embodiment is that, in the fourth embodiment, the diaphragm 32c includes a plurality of first ventilation hole 322c. The first ventilation holes 322c communicate the first cavity 36c and the second cavity 37c. The backplate 33c includes a plurality of second ventilation hole 332c. The second ventilation holes 332c communicate the first cavity 36c and the third cavity 38c. Thus, the first cavity 36c, the second cavity 37c, and the third cavity 38 are communicated each other together. The second cavity 37c is further set as the low-pressure area below atmospheric pressure, and the third cavity 38c is further set as the low-pressure area below atmospheric pressure too. The above structure can reduce the damping between the diaphragm 32c and the backplate 33c, and improve the performance of the bone conduction encapsulation structure 100c.

Comparing with the related art, the present invention provides a bone conduction package structure including a base board, a housing covered with the base board to form a receiving room, a bone conduction MEMS chip located in the receiving room, and an ASIC chip located in the receiving room. The bone conduction MEMS chip includes a substrate having a chamber, a diaphragm supported on the substrate, and a backplate spaced apart from the diaphragm and arranged on one side of the diaphragm distal to the substrate. A first cavity is formed between the diaphragm and the backplate. A second cavity is formed by the diaphragm, the substrate, and the base board. And a third cavity is formed by the backplate, the housing, the substrate, and the base board. The first cavity is set as a low-pressure area below atmospheric pressure.

The bone conduction package structure of the present invention does not require additional vibration plates and weights to detect the change of air pressure. The bone conduction package structure of the present invention directly detects air pressure changes through MEMS chips, which can reduce a volume of the bone conduction package structure. At the same time, the area between the diaphragm and the backplate is set as a low-pressure area to reduce the damping between the diaphragm and the backplate, which improving the performance of the bone conduction packaging structure.

It is to be understood, however, that even though numerous characteristics and advantages of the present exemplary embodiments have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A bone conduction package structure, comprising:
a base board;
a housing covered with the base board to form a receiving room;
a bone conduction MEMS chip located in the receiving room, the bone conduction MEMS chip comprising:
a substrate having a chamber;
a diaphragm supported on the substrate; and
a backplate spaced apart from the diaphragm and arranged on one side of the diaphragm distal to the substrate; and
an ASIC chip located in the receiving room;
wherein a first cavity is formed between the diaphragm and the backplate, a second cavity is formed by the diaphragm, the substrate, and the base board, and a third cavity is formed by the backplate, the housing, the substrate, and the base board, the first cavity is set as a low-pressure area below atmospheric pressure.

2. The bone conduction package structure as described in claim 1, wherein the diaphragm is a complete and impermeable structure, and the backplate is a complete and impermeable structure.

3. The bone conduction package structure as described in claim 1, wherein the diaphragm comprises a plurality of first ventilation holes, the first ventilation holes communicating the first cavity and the second cavity, the second cavity is set as the low-pressure area below atmospheric pressure.

4. The bone conduction package structure as described in claim 1, wherein the backplate comprises a plurality of second ventilation holes, the second ventilation holes communicating the first cavity and the third cavity, the third cavity is set as the low-pressure area below atmospheric pressure.

5. The bone conduction package structure as described in claim 1, wherein the diaphragm comprises a plurality of first ventilation holes, the first ventilation holes communicating the first cavity and the second cavity, the second cavity is set as the low-pressure area below atmospheric pressure, the backplate comprising a plurality of second ventilation holes, the second ventilation holes communicating the first cavity and the third cavity, the third cavity is set as the low-pressure area below atmospheric pressure.

6. The bone conduction package structure as described in claim 1, wherein a weight is provided on a side of the diaphragm away from the backplate.

7. The bone conduction package structure as described in claim 6, wherein the bone conduction MEMS chip further comprises at least one connecting column connecting the weight to the diaphragm on the side of the diaphragm away from the backplate.

8. The bone conduction package structure as described in claim 1, wherein a plurality of anti-stick pillars are disposed on a side of the backplate proximal to the diaphragm.
